(19) United States
(12) Patent Application Publication
(10) Pub. No.: US 2018/0230721 A1
(43) Pub. Date: Aug. 16, 2018

(54) DOOR DEVICE FOR RAILROAD CAR, RAILROAD CAR HAVING THE SAME, EMERGENCY DOOR UNLOCKING DEVICE, AND METHOD OF UNLOCKING DOOR BODY LOCKED WITH LOCKING MECHANISM

(71) Applicant: NABTESCO CORPORATION, Tokyo (JP)

(72) Inventor: Atsuhito YAMAGUCHI, Kobe-shi (JP)

(21) Appl. No.: 15/897,599

(22) Filed: Feb. 15, 2018

(30) Foreign Application Priority Data
Feb. 16, 2017 (JP) 2017-027029

(51) Int. Cl. E05B 83/36; B61D 19/02; B61L 25/02; E05B 81/08; E05B 81/18; E05B 81/46

(52) U.S. Cl. CPC E05B 83/363; B61D 19/02; B61L 25/021; E05B 2047/0026; E05B 81/18; E05B 81/46; E05B 81/08

(57) ABSTRACT

A door device with a locking mechanism includes an operation member that is operated to unlock a door body. When a power supply for a railroad car is normal, it is determined whether the door body is allowed to be opened by operating the operation member. The door body is unlocked only when it is determined that opening of the door body is allowed. Whereas when the power supply for the railroad car is in an abnormal state, the door body is unlocked by the locking mechanism by operating the operation member.

### CROSS-REFERENCE TO RELATED APPLICATIONS

This application is based on and claims the benefit of priority from Japanese Patent Application Serial No. 2017-027029 (filed on Feb. 16, 2017), the contents of which are hereby incorporated by reference in its entirety

### TECHNICAL FIELD

The present invention relates to a door device for railroad cars and a railroad car provided with the door device for a railroad car. The invention also relates to a door unlocking device for unlocking a door body in an emergency and a method of unlocking a door body that is locked by a locking mechanism.

### BACKGROUND

A door device for railroad cars includes a door body and a locking mechanism for locking the door body to maintain the door in a closed state. The door device is designed such that the door body is locked by the locking mechanism while railroad cars travel to prevent the door from unexpectedly being opened for passengers' safety. As a method of opening such a locked door body by a passenger in an emergency, the following procedures are known.

First, when power is properly supplied to a railroad car, a passenger can push a button or the like provided in the vicinity of the door body to send a request signal that requests unlocking of the door body to a member of a crew in a driver seat or the like. After it is determined by the crew member that the door body is allowed to be opened, the passenger mechanically unlocks the door body using a lever or the like provided in the vicinity of the door body. The reason why the passenger needs to obtain such a confirmation from the crew prior to unlocking the door body is that the passenger's safety should be ensured while the railroad car is traveling when the power is normally supplied and it should be confirmed that the speed of the car before the unlocking be below a predetermined speed and any other conditions may be checked if needed. In this example, the lever for unlocking the door body cannot be operated until the confirmation of the crew is obtained.

Whereas when power for opening the door body is not properly supplied, the railroad car is generally stopped. Therefore, it is not necessary to perform the confirmation, and the passenger can unlock the door body simply by operating the lever.

Alternatively, when the above-described lever is operated, not only the unlocking operation of the door is performed but also a request signal for unlocking the door may be transmitted. In this case, the lever may be designed to be operated in two stages. When the power is properly supplied, the lever can be operated only up to the first stage until the confirmation by a crew is obtained. When power is properly supplied, the request signal for requesting unlocking of the door body is transmitted by operating the lever to the first stage by a passenger, and once the confirmation by the crew is obtained, the passenger is allowed to operate the lever to the second stage to unlock the door. Whereas when power is not properly supplied, the passenger immediately unlocks the door body by operating the lever to the second stage with one push.

Here, it is a passenger to perform the unlocking operation of the door body as described above, and it is an emergency that such an unlocking operation is performed. Therefore, it is desirable that the unlocking operation of the door body be simple and the number of steps in the unlocking operation be small so as to be intuitively grasped by passengers.

However, the unlocking operation of the door body when the power is properly supplied is complicated as described above, and is different from the operation that can be intuitively grasped from the lever. More specifically, in order to unlock the door body, it is necessary to press the button before pulling the lever, or to operate the lever in the two stages.

In addition, if an object to be operated or an operation method is different between when the power is properly supplied and when the power is not properly supplied, a passenger has to try two or more operation methods in order to unlock the door body, which hinders prompt unlocking in an emergency.

### SUMMARY

The present invention has been made in view of the above and one object of the invention is to provide a door device with which it is possible to perform unlocking operation of a door body in a simple and intuitive manner in an emergency, and a railroad car provided with the door device. Another object of the invention is to provide a door unlocking device and a method of unlocking a door body with which it is possible to perform unlocking operation of a door body simply and intuitively in an emergency.

A door device according to one aspect of the invention is a door device used for a railroad car. The door device includes: a door body that is openable and closeable; a locking mechanism locking the door body in a closed state; and an operation member operated to unlock the door body. When a power supply for the railroad car is in a normal state, it is determined whether the door body is allowed to be opened by operating the operation member, and the door body is unlocked by the locking mechanism only when it is determined that opening of the door body is allowed, and when the power supply for the railroad car is in an abnormal state, the door body is unlocked by the locking mechanism by operating the operation member.

The door device may further include a timer activated after the operation member is operated. When a predetermined time has elapsed after the timer is activated, it may be determined that the door body is allowed to be opened.

A railroad car according to another aspect of the invention includes the above-described door device, and a car body equipped with the door device.

A railroad car according to another aspect of the invention includes the above-described door device, a car body equipped with the door device, and a speed sensor measuring a speed of the car body. When a measurement result of the speed sensor indicates that the car body is stopped or a detected speed of the car body is at or lower than a predetermined speed, it is determined that the door body is allowed to be opened.

A railroad car according to another aspect of the invention includes a door device equipped with the above-described timer; a car body equipped with the door device; and a speed sensor measuring a speed of the car body. When a measurement result of the speed sensor indicates that the car body is stopped or a detected speed of the car body is at or lower than a predetermined speed and when a predetermined time has elapsed after the timer is activated, it is determined that the door body is allowed to be opened.

A method of unlocking a door body according to another aspect of the invention is a method of unlocking a door body of a railroad car that is locked by a locking mechanism in a closed state. The method includes operating an operation member to unlock the door body; and when a power supply for the railroad car is in a normal state, determining whether the door body is allowed to be opened after the operation member is operated, and unlocking the door body by the locking mechanism only when it is determined that opening of the door body is allowed, when the power supply for the railroad car is in an abnormal state, unlocking the door body by the locking mechanism after the operation member is operated without determining whether opening of the door body is allowed.

In the method of unlocking the door body according to the aspect of the invention, it may be determined that the door body is allowed to be opened when a predetermined time has elapsed after the operation member is operated.

In the method of unlocking the door body, when the car body is stopped or the speed of the car body is at or lower than a predetermined speed, it may be determined that the door body is allowed to be opened.

In the method of unlocking the door body, when the car body is stopped or the speed of the car body is at or lower than a predetermined speed and when a predetermined time has elapsed after the operation member is operated, it may be determined that the door body is allowed to be opened.

A door unlocking device according to another aspect of the invention is a door unlocking device for unlocking a door body of a railroad car locked by a locking mechanism in a closed state. The door unlocking device includes: an operation member operated to unlock the door body; a motion detection sensor detecting a movement of the operation member and transmitting an electric signal; a transmission member transmitting the movement of the operation member to the locking mechanism; and a clutch mechanism engaging and disengaging transmission of the movement from the operation member to the transmission member.

In the door unlocking device, the clutch mechanism disengages transmission of the movement from the operation member to the transmission member when electric power is supplied to the clutch mechanism, and engages transmission of the movement from the operation member to the transmission member when electric power is not supplied to the clutch mechanism.

In the door unlocking device, the clutch mechanism may include a solenoid actuator.

In this case, the solenoid actuator includes an actuator main body supported by one of the operation member or the transmission member, and a movable portion movable relative to the actuator main body. The movable portion may protrude out from the main body to engage the other of the operation member or the transmission member when the solenoid actuator is demagnetized.

In this case, the other of the operation member or the transmission member may have a receiving portion that receives the movable portion of the demagnetized solenoid actuator.

In the door unlocking device, the operation member is movable between a non-operation position where the operation member is situated when the operation member is not operated, and an operation position where the motion detection sensor transmit the electric signal and a second operation position where the door body is allowed to be unlocked by the locking mechanism, and the door unlocking device may further include a holding mechanism that inhibits the operation member from returning to the non-operation position from the operation position or the second operation position after the operation member has been moved to the operation position or the second operation position from the non-operation position.

In this case, the holding mechanism may be a latch mechanism and allows the operation member to move from the operation position and the second operation position so as to move further away from the non-operation position.

In this case, the door unlocking device may further include a casing that holds the operation member such that the operation member is movable from the non-operation position to a third operation position via the operation position and the second operation position. The casing may be deformed by contacting the operation member that moves from the second operation position to the third operation position.

In this case, the casing may have, at a portion where is deformed by contacting the operation member that moves from the second operation position to the third operation position, a strength reduction feature for lowering the strength of the portion.

In the door unlocking device, the clutch mechanism includes a solenoid actuator, the solenoid actuator includes an actuator main body supported by one of the operation member or the transmission member, and a movable portion movable relative to the actuator main body, and the movable portion protrudes out from the main body to engage the other of the operation member or the transmission member when the solenoid actuator is demagnetized, the other of the operation member or the transmission member has a receiving portion that receives the movable portion of the demagnetized solenoid actuator when the operation member is situated at a non-operation position where the operation member is unoperated, and a second receiving portion that receives the demagnetized movable portion when the operation member is situated at a second operation position.

A door device according to another aspect of the invention includes the above-described door unlocking device.

A railroad car according to another aspect of the invention includes the above-described door unlocking device.

According to the aspect of the invention, an operator only has to perform one operation to unlock the door body. Therefore, it is possible to facilitate operator's intuitive grasping of the unlocking operation method of the door body.

### BRIEF DESCRIPTION OF THE DRAWINGS

FIG. 1 is a schematic diagram showing a configuration of a railroad car according to one embodiment of the invention.

FIG. 2 is a front view of a door unlocking device shown in FIG. 1.

FIG. 3 is a cross-sectional view of the door unlocking device shown in FIG. 2.

FIG. 4 is a perspective view of the door unlocking device showing an operation member, a transmission member, and a clutch mechanism in the door unlocking device shown in FIG. 2.

FIG. 5 is a cross-sectional view of the door unlocking device to illustrate the clutch mechanism.

FIG. 6 is a plan view of a locking mechanism in an unlocked state.

FIG. 7 is a plan view of the locking mechanism in a locked state.

FIG. 8 is a side view of the locking mechanism in the locked state.

### DESCRIPTION OF THE EMBODIMENTS

Embodiments of the invention will now be described with reference to the attached drawings.

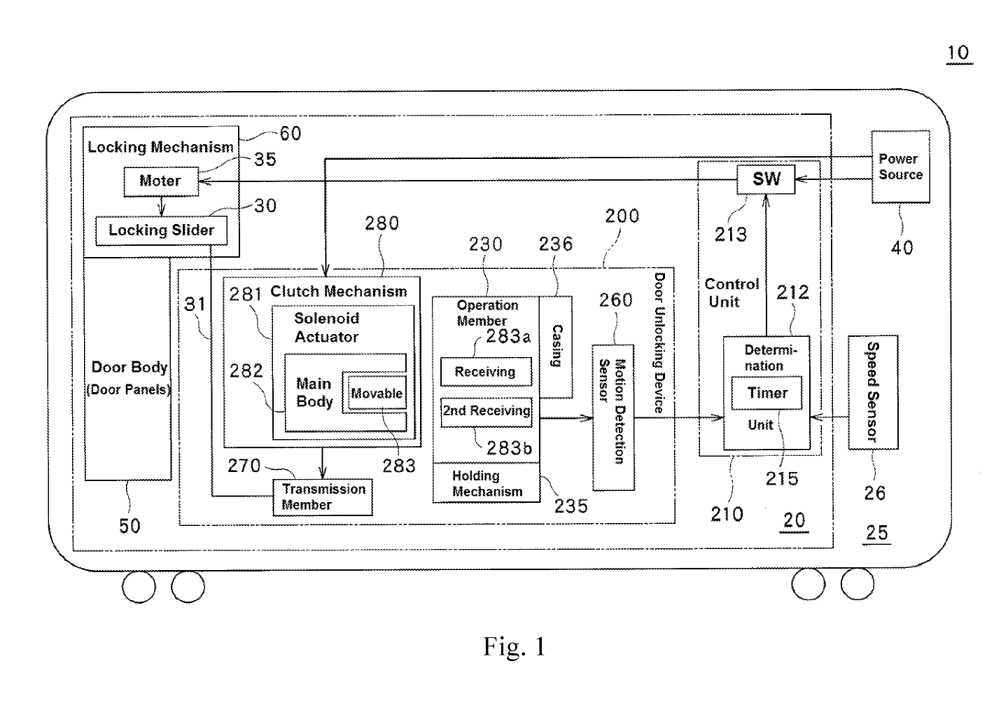

FIG. 1 is a block diagram schematically showing an overall configuration of a railroad car according to an embodiment of the invention. Referring to FIG. 1, a railroad car 10 includes a door device 20, and a car body 25 to which the door device 20 is installed. Electric power is supplied to each part of the railroad car 10 from a power supply 40 provided in the car body 25. The car body 25 is provided with a speed sensor 26 for measuring a speed of the car body 25.

As shown in FIG. 1, the door device 20 includes a door body (door panel) 50 that can be opened and closed, a locking mechanism 60 that locks the door body 50 in a closed state, and a door unlocking device 200 for unlocking the door body 50 of the railroad car 10 with the locking mechanism 60 in an emergency. The locking mechanism 60 has a movable member (locking slider) 30 capable of unlocking the door body 50 by sliding in a hereunder-described unlocking direction within the locking mechanism 60, and a motor 35 that drives the locking slider 30. One end of a wire 31 is connected to the locking slider 30. When electric power is properly supplied from the power supply 40 (hereinafter also referred to as “when the power supply works normally” or “in the normal power supply state”), the door unlocking device 200 is configured to drive the motor 35 of the locking mechanism 60 via a hereunder-described control unit 210 to slide the locking slider 30 in the unlocking direction. Whereas when electric power is not properly supplied from the power supply 40 (hereinafter also referred to as “when there is some failure in the power supply” or “in the abnormal power supply state), the door unlocking device 200 is configured to pull the wire 31 to slide the locking slider 30 in the unlocking direction.

The door device 20 further includes the control unit 210 that controls unlocking of the door body 50 when electric power is properly supplied from the power supply 40.

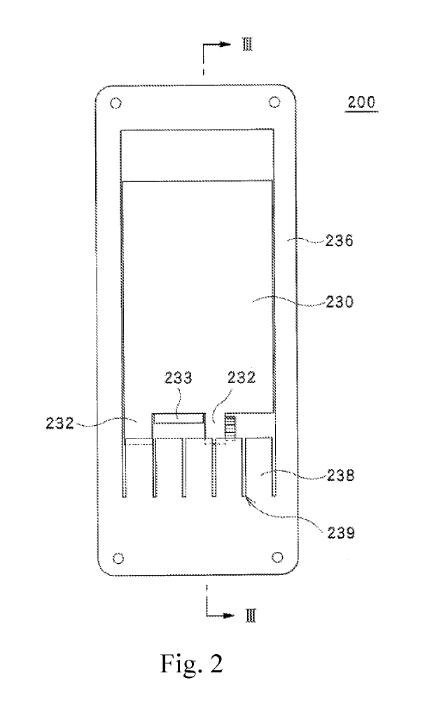

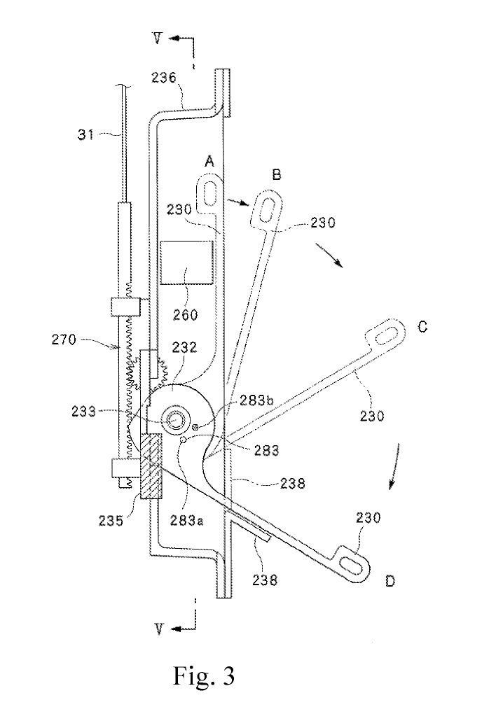

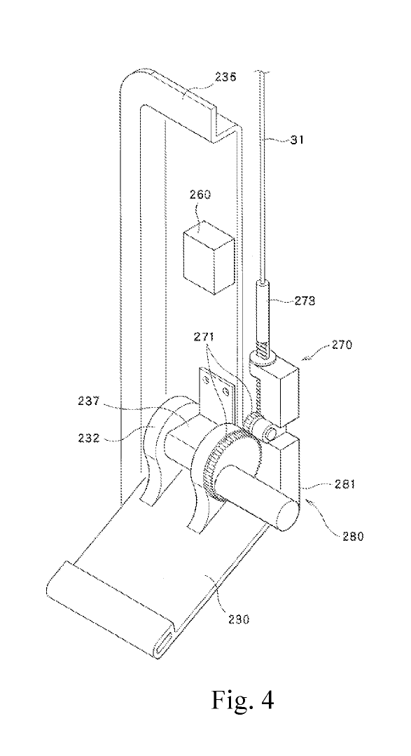

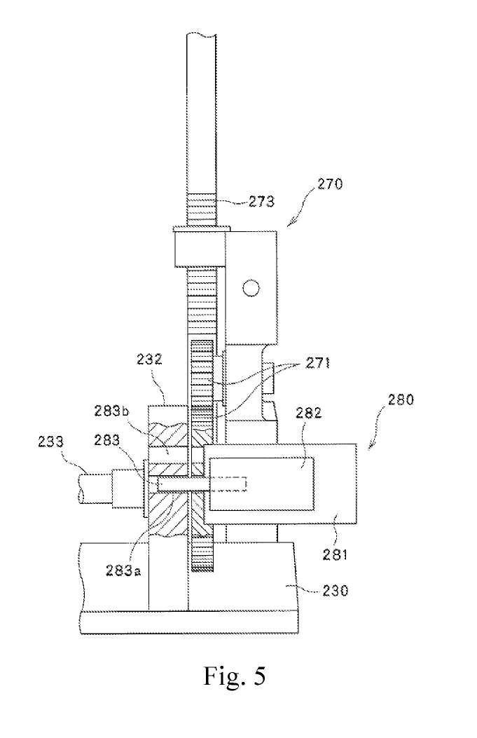

Hereinafter, the door unlocking device 200 of the embodiment will be described in detail with reference to FIGS. 2 to 5. FIG. 2 is a front view of the door unlocking device 200 when it is not operated, and FIG. 3 is a sectional view of the door unlocking device 200 along the line III-III shown in FIG. 2. FIG. 4 is a perspective view of the door unlocking device 200 when it is operated. FIG. 5 is a cross-sectional view of the door unlocking device along the line V-V shown in FIG. 3.

As shown in FIG. 2 and FIG. 3, the door unlocking device 200 includes an operation member 230 that is operated to unlock the door body 50 in an emergency, a casing 236 that holds the operation member 230 such that the operation member 230 is rotatable. Further, the door unlocking device 200 has a motion detection sensor 260 that detects a movement of the operation member 230, and a holding mechanism 235 that restricts movement of the operated operation member 230. Referring to FIG. 4, the door unlocking device 200 includes a transmission member 270 that transmits a movement of the operation member 230 to the locking mechanism 60, and a clutch mechanism 280 that engages and disengages transmission of the movement from the operation member 230 to the transmission member 270.

As shown in FIGS. 2 to 5, the operation member 230 is generally a plate-like member. A bearing 232 is provided on an end portion of one surface of the operation member 230.

The casing 236 has a support portion 237 rotatably supporting a shaft 233 that passes through the bearing 232 of the operation member 230. The casing 236 holds the operation member 230 such that the operation member is movable from a non-operation position A situated when the operation member is not operated, to a third operation position D via an operation position B and a second operation position C. To allow an operator to intuitively grasp even in an emergency that he/she should move the operation member 230 from the non-operation position A to the second operation position C, a portion 238 of the casing 236 is designed such that it comes into contact with the operation member 230 when the operation member 230 is moved to the second operation position C. The portion 238 is also designed to deform such that it allows the operation member 230 to be further moved to the third operation position D if necessary. That is, while the operation member 230 moves from the second operation position C to the third operation position D, the portion 238 is deformed by contacting the operation member 236. More specifically, the portion 238 of the casing 236 has a notch 239 as a strength reduction feature for reducing the strength of the portion 238 where is deformed when it contacts the operation member 236. Other configurations for the strength reduction may be possible such as thinning and formation of a through hole.

When the operation member 230 is moved to the operation position B, the motion detection sensor 260 is configured to transmit an electric signal. The motion detection sensor 260 may include a magnetic sensor, for example, and can detect approach of the operation member 230.

Once the operation member 230 is moved to the operation position B or the second operation position C from the non-operation position A, the holding mechanism 235 inhibits the operation member 230 from returning to the non-operation position A from the operation position B or the second operation position C. In the embodiment, the holding mechanism 235 is a latch mechanism and allows the operation member 230 to move from the operation position B and the second operation position C so as to move further away from the non-operation position A. With such a holding mechanism 235, it is prevented that the operation member 230 that has been moved to the operation position B or the second operation position C returns to the non-operation position A, and if necessary, the operation member 230 can be further moved from the operation position B to the second operation position C or from the second operation position C to the third operation position D.

The clutch mechanism 280 is configured to disengage transmission of the movement from the operation member 230 to the transmission member 270 when electric power is properly supplied from the power supply 40. Whereas when electric power is not properly supplied from the power supply 40, the clutch mechanism 280 is configured to engage transmission of the movement from the operation member 230 to the transmission member 270.

As shown in FIG. 4 and FIG. 5, the clutch mechanism 280 includes a solenoid actuator 281 that receives electric power from the power supply 40 and generates a magnetic field therearound. The solenoid actuator 281 includes an actuator main body 282 supported by the transmission member 270 and a movable portion 283 movable relative to the actuator main body 282. In a state where the solenoid actuator 281 is excited, the movable portion 283 is accommodated in the main body 282, for example, when electric power is normally supplied from the power supply 40. Further, in a state where the solenoid actuator 281 is demagnetized, for example, when electric power supply from the power supply 40 is abnormal, the movable portion 283 protrudes out from the main body 282 to engage with the operation member 230. More specifically, the operation member 230 has a receiving portion 283a that receives the protruded movable portion 283 of the demagnetized solenoid actuator 281. The receiving portion 283a is provided at a position where it can receive the protruded movable portion 283 when the operation member 230 is situated at the non-operation position A. The operation member 230 is further provided with a second receiving portion 283b that receives the protruded movable portion 283 so that the operation member 230 can engage with the movable portion 283 even when the operation member 230 is moved to the second operation position C. More specifically, the second receiving portion 283b is provided at a position where it can receive the protruded movable portion 283 when the operation member 230 is situated at the second operation position C.

In the example shown in FIG. 3, although the operation position B and the second operation position C are situated at different positions, but they may be at the same position. That is, the operation position of the operation member 230 where the motion detection sensor 260 sends an electric signal (the operation position B in the example shown in FIG. 3) and the operation position where the movable portion 283 of the clutch mechanism 280 is able to engage with the second receiving portion 283b (the second operation position C in the example shown in FIG. 3) may correspond with each other.

The actuator main body 282 may be supported by the operation member 230. In this case, the receiving portion 283a and the second receiving portion 283b are provided in the transmission member 270, and the movable portion 283 protruding out from the main body 282 is engaged with the transmission member 270.

The transmission member 270 includes a pinion 271 and a rack 273. When the movable portion 283 of the clutch mechanism 280 is engaged with the operation member 230, the pinion 271 rotates in conjunction with rotation of the operation member 230. The rack 273 is configured to move in the vertical direction in accordance with rotation of the pinion 271. A tip portion of the rack 273 is coupled to the other end of the wire 31 that is coupled to the locking slider 30 of the locking mechanism 60. In this manner, the movement of the rack 273 is transmitted to the locking slider 30 of the locking mechanism 60 via the wire 31.

Referring again to FIG. 1, the control unit 210 will be now described. As shown in FIG. 1, the control unit 210 includes a determination unit 212 that determines whether the door body 50 is allowed to be opened, a switch (SW) unit 213 that electrically connects or disconnects the motor 35 of the locking mechanism 60 to/from the power supply 40.

When the door unlocking device 200 is operated while electric power is supplied properly from the power supply 40, the determination unit 212 determines whether the door body 50 is allowed to be opened. As shown in FIG. 1, the determination unit 212 has a timer 215. The timer 215 is activated upon receiving an electric signal sent from the motion detection sensor 260.

The determination unit 212 determines that the door body 50 is allowed to be opened only when following first condition and second condition are satisfied. The first condition is that a measurement result of the above-described speed sensor 26 shows that the car body 25 is stopped or a detected speed of the car body 25 is at or lower than a predetermined speed. The second condition is that a predetermined time has elapsed since the timer 215 was activated. Alternatively, the determination unit 212 may determine that opening of the door body 50 is allowed when either one of the first condition and the second condition is satisfied.

Moreover, instead of providing the determination unit 212, a member of a crew may determine whether opening of the door body 50 is allowed or not based on the speed sensor 26, the timer 215, and other instruments.

The switch unit 213 is switched so as to supply electric power from the power supply 40 to the motor 35 only when the determination unit 212 determines that opening of the door body 50 is allowed. The switch unit 213 may be operated to be switched by a member of a crew at his/her discretion.

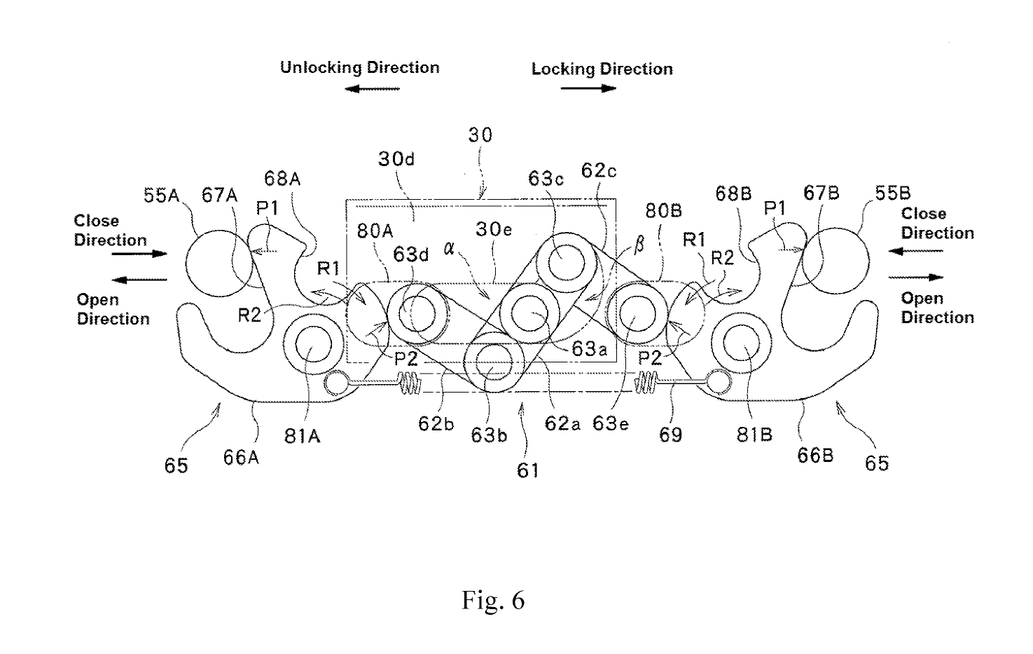

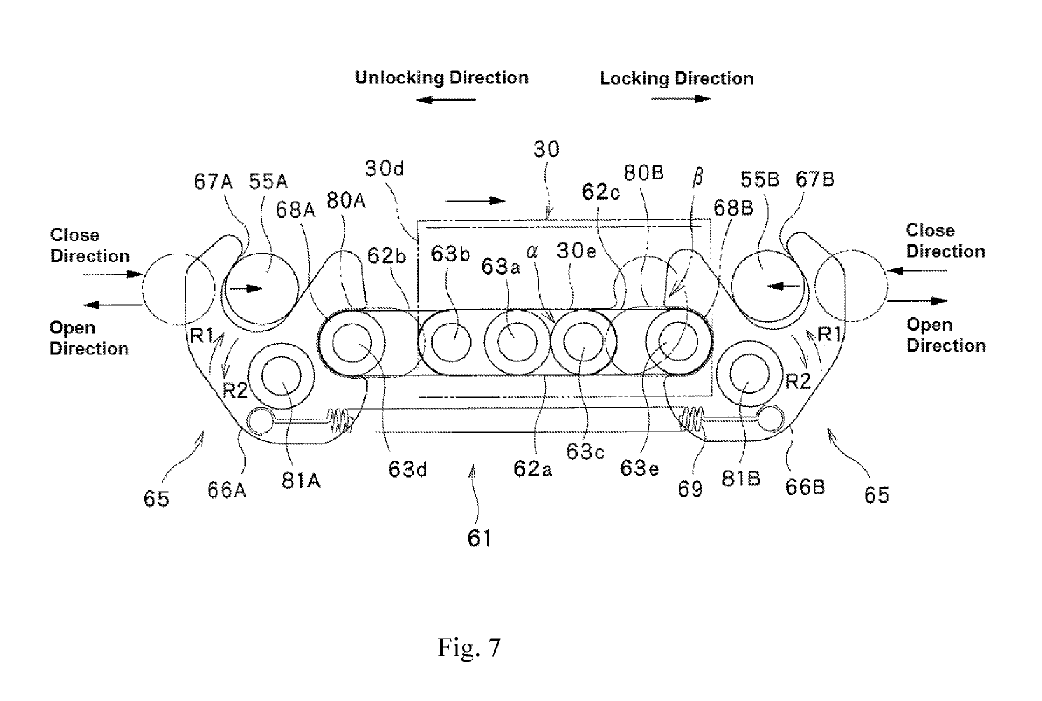

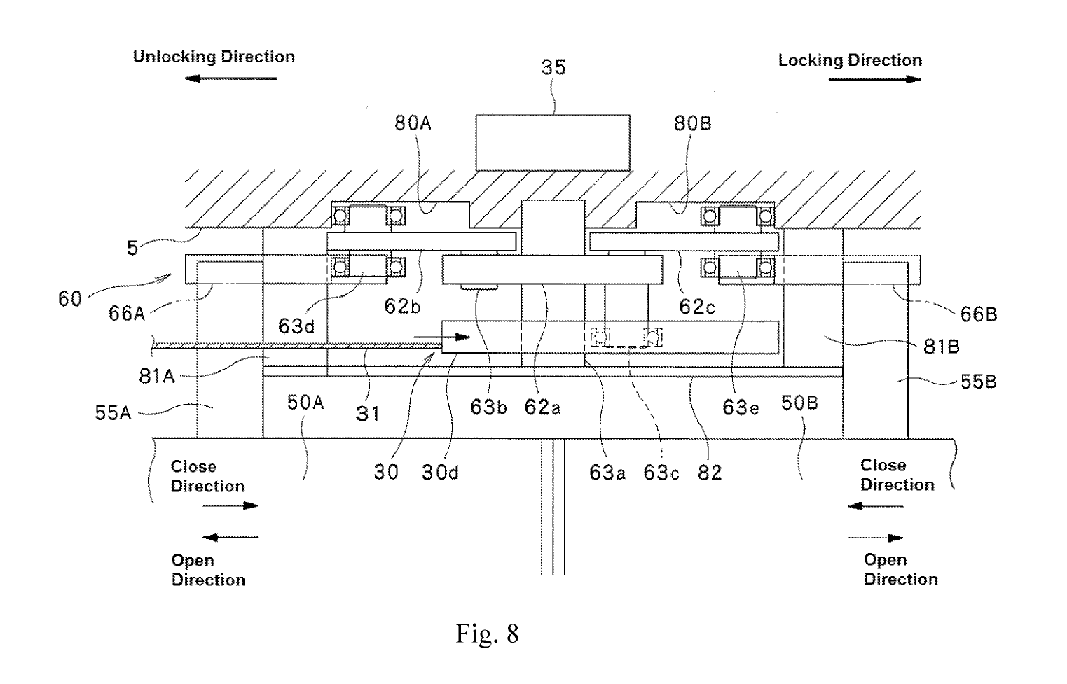

The locking mechanism 60 according the embodiment will be described in detail with reference to FIGS. 6 to 8. FIG. 6 is a plan view of the locking mechanism 60 in an unlocked state, and FIG. 7 is a plan view of the locking mechanism 60 in a locked state. FIG. 8 is a side view of the locking mechanism 60 in the locked state. In the examples shown in FIGS. 6 to 8, the door body 50 includes a pair of right and left door panels 50A and 50B of a sliding type.

As shown in FIG. 8, the locking mechanism 60 is supported by a base 5 that is fixed to the car body 25 above the door body 50. The base 5 extends along the opening and closing direction of the door body 50. As shown in FIGS. 6 to 8, the locking mechanism 60 includes a link mechanism 61 that is deformable between a linear state and a flexion state in a horizontal plane, and a link retaining mechanism 65 that operates within the horizontal plane. The link mechanism 61 is formed by coupling three links 62a, 62b, and 62c. At a central portion in its longitudinal direction, the central link 62a is rotatably fixed to the base 5 by a coupling pin 63a. One end of the central link 62a is coupled to one end of the link 62b by a coupling pin 63b. The other end of the central link 62a is coupled to one end of the link 62c by a guide coupling pin 63c. A pin 63d and a pin 63e are provided at ends of the links 62b, 62c respectively on the side opposite the points of coupling between the links 62b, 62c and the link 62a.

Further, the locking mechanism 60 has the locking slider 30 which is a movable member for switching the locking mechanism 60 between the locked state and the unlocked state. The locking slider 30 is supported by the base 5 and slidable along the opening and closing direction of the door body 50. The locking slider 30 is configured to slide when it receives a driving force exerted by the motor 35. As shown in FIG. 8, one end of the wire 31 is connected to one end of the locking slider 30, and the locking slider is able to slide also by a pulling force exerted by the wire 31.

As shown in FIGS. 6 to 8, the pins 63d and 63e, situated at the ends of the link mechanism 61, have ends thereof respectively inserted in guide grooves 80A and 80B (indicated by alternate long and two short dashes lines in FIGS. 6 and 7) that are formed linearly in the base 5 in parallel to the sliding direction of the locking slider 30. In this way, the pins 63d and 63e are installed so as to be movable along the guide grooves 80A and 80B. In other words, the movements of the pins 63d and 63e are respectively restricted by the guide grooves 80A and 80B.

An end of the guide coupling pin 63c of the link mechanism 61 situated closer to the locking slider 30 is inserted in a slit 30e of the locking slider 30. The slit 30e has a first hole α that is formed lineally in parallel to the moving direction of the locking slider 30, and a second hole β that has a curved shape and is connected to the end portion of the first hole α on the side closer to the guide groove 80B. The first hole α is aligned with the guide grooves 80A, 80B in the moving direction of the locking slider 30. On the other hand, an end of the second hole β on the side opposite to the side connected to the first hole α is not aligned with the first hole α and the guide grooves 80A, 80B in the moving direction of the locking slider 30. The guide connecting pin 63c is configured such that it can be displaced from the first hole α to the second hole β or from the second hole β to the first hole α according to the position of the locking slider 30. The position of the guide coupling pin 63c is thus restricted by the position of the locking slider 30. Therefore the central link 62a is rotated by the movement of the locking slider 30 and it is possible to switch between the linear state and the flexion state of the link mechanism 61.

The link retaining mechanism 65 includes a pair of engaging members 66A and 66B that are provided near the respective ends of the link mechanism 61 symmetrically with reference to the link mechanism 61 (with reference to the coupling pin 63a) such that they are rotatable within the horizontal plane. The link retaining mechanism 65 further includes a coupling spring 69 that couples the pair of engaging members to each other. The engaging members 66A and 66B respectively have, at peripheral portions thereof, first engaging portions 67A and 67B and second engaging portions 68A and 68B that are formed in concave shapes. Rotation shafts 81A and 81B of the engaging members 66A and 66B are fixedly provided on the base 5 (see FIG. 8). A bridge member 82 is fixed to the pair of rotation shafts 81A and 81B, and the coupling pin 63a for rotatably fixing the central link 62a of the link mechanism 61 is supported by the bridge member 82.

When no external force exerts on the link retaining mechanism 65, the engaging members 66A and 66B receive a force from the coupling spring 69 and are retained in the state as shown in FIG. 6. In this state, the engaging members 66A and 66B constrain, by their peripheral portions (portions indicated by the arrows P2 in FIG. 6), an extending movement of the link mechanism 61 into the linear state. When the link mechanism 61 is thus held in the flexion state by the engaging members 66A and 66B, the locking slider 33 is prevented from moving in the locking direction (the direction indicated by the arrow in FIG. 6) via the slit 33e and the guide coupling pin 63c.

Meanwhile, when edges (portions indicated by P1 in FIG. 6) of the first engaging portions 67A and 67B are urged by the movement of the locking pins 55A and 55B in the closing directions (directions indicated by the arrows in FIG. 6) that are respectively fixed to the door panels 50A and 50B, the engaging members 66A and 66B turn in directions (directions indicated by the arrows R1 in FIG. 6) in which the second engaging portions 68A and 68B approach the link mechanism 61 against the urging force of the coupling spring 69. In a state where the door panels 50A and 50B are in a fully closed position, the locking pins 55A, 55B and the first engaging portions 67A, 67B are engaged with each other as shown in FIG. 7, and the second engaging portions 68A and 68B are situated at the positions where they can engage with the pins 63d and 63e disposed at the ends of the link mechanism 61. That is, the engaging members 66A and 66B are in a state where they do not constrain the deformation of the link mechanism 61. If at this point, the locking slider 30 moves in the locking direction, the link mechanism 61 is made to transition from the flexion state to the linear state by the guide connecting pin 63c that moves along the slit 33e. The pins 63d and 63e that are situated at the ends of the link mechanism 61 then engage with the second engaging potions 68A and 68B of the engaging members 66A and 66B respectively. Turning of the engaging members 66A and 66B are thereby constrained. Movements of the locking pins 55A and 55B in opening directions (directions indicated by the arrows in FIG. 7) are thus constrained by the first engaging portions 67A and 67B.

Next, operation of the railroad car 10 having the door device 20 of the embodiment will be described.

When an operator tries to open the door body 50, the door body 50 is closed and locked by the locking mechanism 60. That is, the link mechanism 61 in the locking mechanism 60 is in the linear state shown in FIG. 7. Further, the operation member 230 of the door unlocking device 200 is in the non-operation position A shown in FIGS. 2 and 3. The switch unit 213 is switched to the position where electric power is not supplied to the motor 35 of the locking mechanism 60 from the power supply 40.

Firstly described is a case where electric power is properly supplied to the railroad car 10 from the power supply 40 when an operator begins to operate the operation member 230. In this case, the solenoid actuator 281 of the clutch mechanism 280 in the door unlocking device 200 is excited by electric power supplied from the power supply 40. Therefore, the movable portion 283 of the clutch mechanism 280 remains accommodated in the main body 282 and is not engaged with the operation member 230. Accordingly, even if the operator operates the operation member 230, the operational movement of the operation member 230 is not transmitted to the transmission member 270.

In this state, in order to unlock the door body 50 that has been locked in the closed state by the locking mechanism 60, the operator moves the operation member 230 of the door unlocking device 200 from the non-operation position A to the operation position B. When the operation member 230 is moved, the movement of the operation member 230 is detected by the motion detection sensor 260. When the operation member 230 is moved to the operation position B, an electric signal is transmitted by the motion detection sensor 260.

The operation member 230 that has been moved to the operation position B is held by the holding mechanism 235 of the door unlocking device 200. Consequently the operation member 230 is retained at the operation position B without returning to the non-operation position A.

When the determination unit 212 receives the electric signal from the motion detection sensor 260, the determination unit 212 activates the timer 215 and determines whether opening of the door body 50 is allowed. More specifically, the determination unit 212 determines if a measurement result of the above-described speed sensor 26 shows that the car body 25 is stopped or a detected speed of the car body 25 is at or lower than a predetermined speed (the first condition). Further, the determination unit 212 determines if a predetermined time has elapsed after the operation member 230 is operated, that is, determines if a predetermined time has elapsed since the timer 215 was activated (the second condition). The determination unit 212 determines that the door body 50 is allowed to be opened after confirming that the first condition and the second condition are satisfied. Note that the car body 25 can be moved to a place suitable for a crew to get off the car after the timer 215 is activated and before the predetermined time elapses.

When the determination unit 212 determines that the door body 50 is allowed to be opened, the switch unit 213 is switched such that electric power is supplied from the power supply 40 to the motor 35 of the locking mechanism 60. When electric power is supplied to the motor 35, the locking slider 30 receives the driving force of the motor 35 and slides in the unlocking direction.

Here, the determination as to whether opening of the door body 50 is allowed may be made by a member of a crew based on information obtained from the speed sensor 26, the timer 215 and other instruments as described above. In addition, the operation of releasing the locking mechanism 60, such as switching of the switch unit 213 may also be carried out manually by a member of a crew.

As the locking slider 30 is moved in the unlocking direction, the guide connecting pin 63c of the link mechanism moves along the edge of the slit 30e from the first hole α to the second hole β. Thereby the link mechanism 61 is made a transition from the linear state to the flexion state. Consequently engagements between the second engaging potions 68A, 68B of the engaging members 66A, 66B and the pins 63d, 63e that are situated at the ends of the link mechanism 61 are released. Then, due to the tensile elastic force of the connecting spring 69 that connects the pair of engaging members 66A, 66B, the engaging members 66A, 66B receives the force that turns the first engaging portions 67A, 67B in the R2 direction shown in FIG. 7 to face outward (to face away from the link mechanism 61). The locking pins 55A and 55B that are engaged with the second engaging portions 68A and 68B respectively are thereby allowed to move in the opening directions and the door panels 50A and 50B are unlocked.

Once the door is unlocked, an operator draws the door panels 50A, 50B to open the door body 50.

Next, described is a case where power supply to the railroad car 10 from the power supply 40 is abnormal when an operator begins to operate the operation member 230. In this case, the solenoid actuator 281 of the clutch mechanism 280 is demagnetized since it does not receive the electric power from the power supply 40. Accordingly, the movable portion 283 protrudes out from the main body 282. The movable portion 283 that protrudes from the main body 282 is received by a receiving portion 283a of the operation member 230 and is engaged with the operation member 230.

In this state, when the operator moves the operation member 230 from the non-operation position A to the second operation position C, this movement of the operation member 230 is transmitted to the transmission member 270 via the clutch mechanism 280. The pinion 271 of the transmission member 270 rotates in accordance with the movement of the operation member 230 to move the rack 273 in the downward direction. Consequently, the wire 31 whose other end is connected to the tip of the rack 273 is pulled downward.

When the wire 31 is pulled downward, the locking slider 30 of the locking mechanism 60 slides in the unlocking direction by the pulling force of the wire 31. As a result, the door body 50 is unlocked by the locking mechanism 60.

Described next is a case where some failure occurs in the power supply 40 of the railroad car 10 after an operator begins to operate the operation member 230, more specifically, during the operator moves the operation member 230 from the non-operation position A to the second operation position C, or after the operator moved the operation member to the second operation position C.

In this case, due to occurrence of a failure in the power supply 40, the solenoid actuator 281 of the clutch mechanism 280 shifts from the excited state to the demagnetized state. Therefore the movable portion 283 accommodated in the main body moves relative to the main body 282 and protrudes out from the main body 282. When the operation member 230 is moved to the second operation position C (if the operation member 230 has been moved to the second operation position C, at the second operation position C), the movable portion 283 that protrudes out from the main body 282 is received by the second receiving portion 283b of the operation member 230, and engaged with the operation member 230.

In this state, when the operator further moves the operation member 230 to the third operation position D, this movement of the operation member 230 is transmitted to the transmission member 270 via the clutch mechanism 280. Consequently, the wire 31 that is connected to the rack 273 of the clutch mechanism 280 is pulled downward. The locking slider 30 of the locking mechanism 60 slides in the unlocking direction when the wire 31 is pulled downward, and the door body 50 is unlocked by the locking mechanism 60. The displacement of the operation member 230 from the second operation position C to the third operation position D is not hindered because the portion 238 provided with the strength reduction feature of the casing 236 deforms when the operation member 230 comes into contact with the portion 238.

As for the door device 20 used for the railroad car 10 according to the embodiment, the door device 20 includes the door body 50 that can be opened and closed, the locking mechanism 60 for locking the door body 50 in a closed state, and the operation member 230 that is operated to unlock the door body 50. When the power supply 40 of the railroad car 10 is normal, it is determined whether the door body 50 is allowed to be opened by operating the operation member 230. The door body 50 is unlocked by the locking mechanism 60 only when it is determined that opening of the door body 50 is allowed. Whereas when the power supply 40 of the railroad car 10 is in an abnormal state, the door body 50 is unlocked by the locking mechanism 60 by operating the operation member 230.

According to the above-described door device 20, an operator has to perform only one movement to unlock the door body 50 in an emergency. Therefore, it is possible to facilitate operator's intuitive grasping of the unlocking operation method of the door body 50. Further, the operation object and the operation method are the same between the normal power supply state and the abnormal power supply state. Therefore, it is possible to prompt an operator to try one operation method that is intuitively grasped from the operation member 230 to unlock the door body 50.

Moreover, the door device 20 further includes the timer 215 that is activated after the operation member 230 is operated. When a predetermined time has elapsed after the timer 215 is activated, it is determined that the door body 50 is allowed to be opened. According to the door device 20, after the operation member 230 is operated and before the door body 50 is unlocked by the locking mechanism 60, the speed of the car body 25 can be sufficiently reduced or the car body 25 can be moved to a place suitable for letting passengers and a crew get off. Therefore, it is possible to secure the safety of the crew of the railroad car 10.

The railroad car 10 according to an embodiment includes the above-described door device 20, and the car body 25 equipped with the door device 20.

According to the above-described railroad car 10, an operator only has to perform one movement to unlock the door body 50 in an emergency. Therefore, it is possible to facilitate operator's intuitive grasping of the unlocking operation method of the door body 50. Further, the operation object and the operation method are the same between the normal power supply state and the abnormal power supply state. Therefore, it is possible to prompt an operator to try one operation method that is intuitively grasped from the operation member 230 to unlock the door body 50.

The railroad car 10 according to an embodiment includes the above-described door device 20, the car body 25 equipped with the door device 20, and the speed sensor 26 that measures the speed of the car body 25. When a measurement result of the speed sensor 26 indicates that the car body 25 is stopped or a detected speed of the car body 25 is at or lower than a predetermined speed, it is determined that the door body 50 is allowed to be opened.

According to the railroad car 10 as described above, the door body 50 is unlocked after the car body 25 is stopped or after the speed of the car body 25 is sufficiently reduced. Therefore, it is possible to secure the safety of the crew of the railroad car 10.

The railroad car 10 according to an embodiment includes the above-described door device 20 equipped with the timer 215, the car body 25 equipped with the door device 20, and the speed sensor 26 that measures the speed of the car body 25. When a measurement result of the speed sensor 26 indicates that the car body 25 is stopped or a detected speed of the car body 25 is at or lower than a predetermined speed and when a predetermined time has elapsed after the timer 215 is activated, it is determined that the door body 50 is allowed to be opened.

According to the railroad car 10 as described above, the door body 50 is unlocked after the car body 25 is stopped or after the speed of the car body 25 is sufficiently reduced. Further, after the operation member 230 is operated and before the door body 50 is unlocked by the locking mechanism 60, it is possible to move the car body 25 to a place suitable for letting people getting off from the car. Therefore, it is possible to secure the safety of the crew of the railroad car 10.

A method of unlocking the door body 50 of the railroad car 10 locked by the locking mechanism in a closed state according to an embodiment includes: operating the operation member 230 to unlock the door body 50; and when the power supply for the railroad car 10 is in a normal state, determining whether the door body 50 is allowed to be opened after the operation member 230 is operated, and unlocking the door body 50 by the locking mechanism 60 only when it is determined that opening of the door body 50 is allowed, and when the power supply 40 for the railroad car 10 is in an abnormal state, unlocking the door body 50 by the locking mechanism 60 after the operation member 230 is operated without determining whether opening of the door body 50 is allowed.

According to this unlocking method, an operator only has to perform one operation to unlock the door body 50 in an emergency. Therefore, it is possible to facilitate operator's intuitive grasping of the unlocking operation method of the door body 50. Further, the operation object and the operation method are the same between the normal power supply state and the abnormal power supply state. Therefore, it is possible to prompt an operator to try one operation method that is intuitively grasped from the operation member 230 to unlock the door body 50.

In addition, in the above-described unlocking method, it is determined that the door body 50 is allowed to be opened when a predetermined time has elapsed after the operation member 230 is operated. According to this unlocking method, after the operation member 230 is operated and before the door body 50 is unlocked by the locking mechanism 60, the speed of the car body 25 can be sufficiently reduced or the car body 25 can be moved to a place suitable for letting passengers and a crew get off. Therefore, it is possible to secure the safety of the crew of the railroad car 10.

In the above described unlocking method, when the car body 25 is stopped or the speed of the car body 25 is at or lower than a predetermined speed, it is determined that the door body 50 is allowed to be opened. According to the unlocking method, the door body 50 is unlocked after the car body 25 is stopped or after the speed of the car body 25 is sufficiently reduced. Therefore, it is possible to secure the safety of the crew of the railroad car 10.

In the above described unlocking method, when the car body 25 is stopped or the speed of the car body 25 is at or lower than a predetermined speed and when a predetermined time has elapsed after the operation member 230 is operated, it is determined that the door body 50 is allowed to be opened. According to the unlocking method, the door body 50 is unlocked after the car body 25 is stopped or after the speed of the car body 25 is sufficiently reduced. Further, after the operation member 230 is operated and before the door body 50 is unlocked by the locking mechanism 60, it is possible to move the car body 25 to a place suitable for letting people getting off from the car. Therefore, it is possible to secure the safety of the crew of the railroad car 10.

The door unlocking device 200 according to an embodiment for unlocking the door body 50 of the railroad car 10 locked by the locking mechanism 60 in a closed state, includes the operation member 230 operated to unlock the door body 50, the motion detection sensor 260 that detects a movement of the operation member 230 and transmits an electric signal, the transmission member 270 that transmits the movement of the operation member 230 to the locking mechanism 60, and the clutch mechanism 280 that engages and disengages transmission of the movement from the operation member 230 to the transmission member 270.

According to the above-described door unlocking device 200, an operator has to perform only one movement to unlock the door body 50 in an emergency. Therefore, it is possible to facilitate operator's intuitive grasping of the unlocking operation method of the door body 50. Further, it is possible to make the operation object and the operation method same between the normal power supply state and the abnormal power supply state. Therefore, it is possible to prompt an operator to try one operation method that is intuitively grasped from the operation member 230 to unlock the door body 50.

More specifically, the clutch mechanism 280 disengages transmission of the movement from the operation member 230 to the transmission member 270 when electric power is supplied to the clutch, and engages transmission of the movement from the operation member 230 to the transmission member 270 when electric power is not supplied to the clutch. According to this door unlocking device 200, it is easy to make the operation object and the operation method same between the normal power supply state and the abnormal power supply state. Therefore, it is possible to prompt an operator to try one operation method that is intuitively grasped from the operation member 230 to unlock the door body 50.

More specifically the clutch mechanism 280 includes the solenoid actuator 281. The solenoid actuator 281 includes the actuator main body 282 supported by one of the operation member 230 or the transmission member 270, and the movable portion 283 movable relative to the actuator main body 282. The movable portion 283 protrudes out from the main body 282 to engage the other of the operation member 230 or the transmission member 270 when the solenoid actuator 281 is demagnetized. The other of the operation member 230 or the transmission member 270 has the receiving portion 283a that receives the movable portion 283 of the demagnetized solenoid actuator 281.

In the door unlocking device 200, the operation member 230 is movable between the non-operation position A where the operation member 230 is situated when the operation member 230 is not operated, and the operation position B where the motion detection sensor 260 transmit the electric signal and the second operation position C where the door body 50 is allowed to be unlocked by the locking mechanism 60. The door unlocking device 200 further includes the holding mechanism 235 that inhibits the operation member 230 from returning to the non-operation position A from the operation position B or the second operation position C after the operation member 230 has been moved to the operation position B or the second operation position C from the non-operation position A. According to this door unlocking device 200, it is possible to prevent the operation member 230 from returning to the non-operation position A after the operation member 230 has been moved to the operation position B so that insufficient transmission of the electric signal by the motion detection sensor 260 is prevented. Moreover, it is possible to prevent the operation member 230 from returning to the non-operation position A after the operation member 230 has been moved to the second operation position C so that it is possible to prevent that the door body 50 is unintentionally locked again.

More specifically, the holding mechanism 235 is a latch mechanism and allows the operation member 230 to move from the operation position B and the second operation position C so as to move further away from the non-operating position A. According to this door unlocking device 200, it is possible to further move the operation member 230 that is situated at the operation position B or the second operation position C to move away from the non-operation position A. In this way, it is possible to secure an operation amount of the operation member 230 necessary for unlocking the door body 50 by the locking mechanism 60 in preparation for occurrence of a failure of the power supply during operation of the operation member 230.

The door unlocking device 200 may further include the casing 236 that holds the operation member 230 such that the operation member 230 is movable from the non-operation position A to the third operation position D via the operation position B and the second operation position C. The casing 236 is deformed by contacting the operation member 230 that moves from the second operation position C to the third operation position D. According to this door unlocking device 200, an operator is able to intuitively grasp even in an emergency that he/she should move the operation member 230 from the non-operation position A to the operation position B, and moreover it is possible for the operator to stably operate the operation member 230 from the non-operation position A to the operation position B.

More specifically, the casing 236 has, at a portion 238 where is deformed by contacting the operation member 230 that moves from the second operation position C to the third operation position D, the strength reduction feature 239 for lowering the strength of the portion 238.

Further in the door unlocking device 200, the clutch mechanism 280 includes the solenoid actuator 281. The solenoid actuator 281 includes the actuator main body 282 supported by one of the operation member 230 or the transmission member 270, and the movable portion 283 movable relative to the actuator main body 282. The movable portion 283 protrudes out from the main body 282 to engage the other of the operation member 230 or the transmission member 270 when the solenoid actuator 281 is demagnetized. The other of the operation member 230 or the transmission member 270 has a receiving portion 283a that receives the movable portion 283 of the demagnetized solenoid actuator 281 when the operation member 230 is situated at a non-operation position A where the operation member 230 is unoperated, and the second receiving portion 283b that receives the movable portion 283 of the demagnetized solenoid actuator 281 when the operation member 230 is situated at the second operation position C.

According to this door unlocking device 200, it is easy to make the operation object and the operation method same between the normal power supply state and the abnormal power supply state. Due to the presence of the receiving portions 283a and 283b, even when any failure occurs in the power supply after operation of the operating member 230 is started, the movable portion 283 of the clutch mechanism 280 is engaged with the operation member 230 or the transmission member 270 to allow the door body 50 to be unlocked by the locking mechanism 60.

The door device 20 according to an embodiment includes the above-described door unlocking device 200. According to this door device 20, an operator has to perform only one movement to unlock the door body 50 in an emergency. Therefore, it is possible to facilitate operator's intuitive grasping of the unlocking operation method of the door body 50. Further, it is possible to make the operation object and the operation method same between the normal power supply state and the abnormal power supply state. Therefore, it is possible to prompt an operator to try one operation method that is intuitively grasped from the operation member 230 to unlock the door body 50.

The railroad car 10 according to an embodiment include the above-described door unlocking device 200. According to this door device 20, an operator has to perform only one movement to unlock the door body 50 in an emergency. Therefore, it is possible to facilitate operator's intuitive grasping of the unlocking operation method of the door body 50. Further, it is possible to make the operation object and the operation method same between the normal power supply state and the abnormal power supply state. Therefore, it is possible to prompt an operator to try one operation method that is intuitively grasped from the operation member 230 to unlock the door body 50.

The embodiments described herein represent a number of possible examples and is not intended to limit the scope of the invention. The foregoing embodiments may be implemented in various other ways and various omissions, replacements and modifications can be made to the embodiments without departing from the spirit of the invention. The embodiments and any such modifications are intended to be included within the spirit and scope of the invention and included in the scope of the invention defined by the following claims and equivalents thereof.

What is claimed is:

1. A door device used for a railroad car, comprising:
a door body that is openable and closeable;
a locking mechanism locking the door body in a closed state; and
an operation member operated to unlock the door body,
wherein when a power supply for the railroad car is in a normal state, it is determined whether the door body is allowed to be opened by operating the operation member, and the door body is unlocked by the locking mechanism only when it is determined that opening of the door body is allowed, and
when the power supply for the railroad car is in an abnormal state, the door body is unlocked by the locking mechanism by operating the operation member.

2. The door device according to claim 1, further comprising:
a timer activated after the operation member is operated,
wherein when a predetermined time has elapsed after the timer is activated, it is determined that the door body is allowed to be opened.

3. A railroad car comprising:
the door device according to claim 1: and
a car body equipped with the door device.

4. A railroad car comprising:
the door device according to claim 1;
a car body equipped with the door device; and
a speed sensor measuring a speed of the car body,
wherein when a measurement result of the speed sensor indicates that the car body is stopped or a detected speed of the car body is at or lower than a predetermined speed, it is determined that the door body is allowed to be opened.

5. A railroad car comprising:
the door device according to claim 2;
a car body equipped with the door device; and
a speed sensor measuring a speed of the car body,
wherein when a measurement result of the speed sensor indicates that the car body is stopped or a detected speed of the car body is at or lower than a predetermined speed and when a predetermined time has elapsed after the timer is activated, it is determined that the door body is allowed to be opened.

6. A method of unlocking a door body of a railroad car that is locked by a locking mechanism in a closed state, comprising:
operating an operation member to unlock the door body; and
when a power supply for the railroad car is in a normal state, determining whether the door body is allowed to be opened after the operation member is operated, and unlocking the door body by the locking mechanism only when it is determined that opening of the door body is allowed, and when the power supply for the railroad car is in an abnormal state, unlocking the door body by the locking mechanism after the operation member is operated without determining whether opening of the door body is allowed.

7. The method according to claim 6, wherein it is determined that the door body is allowed to be opened when a predetermined time has elapsed after the operation member is operated.

8. The method according to claim 6, wherein when the car body is stopped or the speed of the car body is at or lower than a predetermined speed, it is determined that the door body is allowed to be opened.

9. The method according to claim 6, wherein when the car body is stopped or the speed of the car body is at or lower than a predetermined speed and when a predetermined time has elapsed after the operation member is operated, it is determined that the door body is allowed to be opened.

10. A door unlocking device for unlocking a door body of a railroad car locked by a locking mechanism in a closed state, comprising:
an operation member operated to unlock the door body;
a motion detection sensor detecting a movement of the operation member and transmitting an electric signal;
a transmission member transmitting the movement of the operation member to the locking mechanism; and
a clutch mechanism engaging and disengaging transmission of the movement from the operation member to the transmission member.

11. The door unlocking device according to claim 10, wherein the clutch mechanism disengages transmission of the movement from the operation member to the transmission member when electric power is supplied to the clutch mechanism, and engages transmission of the movement from the operation member to the transmission member when electric power is not supplied to the clutch mechanism.

12. The door unlocking device according to claim 10, wherein
the clutch mechanism includes a solenoid actuator,
the solenoid actuator includes an actuator main body supported by one of the operation member or the transmission member, and a movable portion movable relative to the actuator main body, and
the movable portion protrudes out from the main body to engage the other of the operation member or the transmission member when the solenoid actuator is demagnetized.

13. The door unlocking device according to claim 12, wherein the other of the operation member or the transmission member has a receiving portion that receives the movable portion of the demagnetized solenoid actuator.

14. The door unlocking device according to claim 10, wherein
the operation member is movable between a non-operation position where the operation member is situated when the operation member is not operated, and an operation position where the motion detection sensor transmit the electric signal and a second operation position where the door body is allowed to be unlocked by the locking mechanism, and
the door unlocking device further includes a holding mechanism that inhibits the operation member from returning to the non-operation position from the operation position or the second operation position after the operation member has been moved to the operation position or the second operation position from the non-operation position.

15. The door unlocking device according to claim 14, wherein the holding mechanism is a latch mechanism and allows the operation member to move from the operation position and the second operation position so as to move further away from the non-operation position.

16. The door unlocking device according to claim 15, further comprising:
a casing that holds the operation member such that the operation member is movable from the non-operation position to a third operation position via the operation position and the second operation position,
wherein the casing is deformed by contacting the operation member that moves from the second operation position to the third operation position.

17. The door unlocking device according to claim 16, wherein the casing has, at a portion where is deformed by contacting the operation member that moves from the second operation position to the third operation position, a strength reduction feature for reducing the strength of the portion.

18. The door unlocking device according to claim 12, wherein
the clutch mechanism includes a solenoid actuator,
the solenoid actuator includes an actuator main body supported by one of the operation member or the transmission member, and a movable portion movable relative to the actuator main body, and
the movable portion protrudes out from the main body to engage the other of the operation member or the transmission member when the solenoid actuator is demagnetized,
the other of the operation member or the transmission member has a receiving portion that receives the movable portion of the demagnetized solenoid actuator when the operation member is situated at a non-operation position where the operation member is unoperated, and a second receiving portion that receives the demagnetized movable portion when the operation member is situated at a second operation position.

19. A door device comprising the door unlocking device according to claim 10.

20. A railroad car comprising the door unlocking device according to claim 10.
